(19) United States
(12) Patent Application Publication
(10) Pub. No.: US 2008/0185085 A1
(43) Pub. Date: Aug. 7, 2008

(54) Pneumatic Tire

(75) Inventor: Toshiyuki Ohashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd.

(21) Appl. No.: 12/026,699

(22) Filed: Feb. 6, 2008

(30) Foreign Application Priority Data
Feb. 7, 2007 (JP) 2007-028225

(51) Int. Cl. B60C 11/12

(52) U.S. Cl. 152/209.23

(57) ABSTRACT

The invention provides a pneumatic tire which can obtain a sufficient engagement force in a depth direction in comparison with a known pattern while making good use of an advantage of a waveform sipe, and is hard to be affected in an inhibiting effect in accordance with a collapsing direction of a block. In a pneumatic tire provided with a tread pattern having a plurality of blocks forming a plurality of sipes therein, the sipe is formed in a zigzag or wavy line shape on a surface of the block and formed as a waveform groove in a depth direction, and the waveform groove has an auxiliary wavy portion in a wavy surface direction, and has a concave portion in a peak portion of the wave.

### BACKGROUND OF THE INVENTION

1. Field of the Invention

The present invention relates to a pneumatic tire provided with a tread pattern having a plurality of blocks forming a plurality of sipes therein. The pneumatic tire in accordance with the present invention is particularly suitable for a studless tire.

2. Description of the Related Art

For the purpose of improving an ice performance of the studless tire, there has been known a tread pattern in which a plurality of sipes are arranged in each of portions (a center portion, a mediate portion and a shoulder portion) of a tire pattern. As a shape of the sipe mentioned above, conventionally, there has generally been a flat or waveform sipe which is not changed in shape in a depth direction of the sipe. Since an edge effect, a drainage effect and an adhesion effect are improved by forming the sipe mentioned above in the block, a number of the sipe tends to be increased in recent years.

Accordingly, if the number of the sipe is increased and a sipe density is increased as mentioned above, a rigidity of a whole of the block is lowered in spite that the number of the edge is increased. Therefore, since a block constructing rubber at a time when the tire is grounded is deformed so as to collapse, an edge effect becomes inversely smaller, and there is generated a problem that the ice performance is lowered. Accordingly, there has been remarked in recent years a so-called three-dimensional sipe in which the collapse of the sipe is inhibited by changing the shape of the sipe in a depth direction (for example, Japanese Unexamined Patent Publication No. 1993-58118, Japanese Unexamined Patent Publication No. 2000-6619 and Japanese Patent No. 3516647)

A pneumatic tire disclosed in the Japanese Unexamined Patent Publication No. 1993-58118 corresponds to a studless tire in which at least one sipe in a tire width direction is provided in a block for inhibiting the collapse of the sipe, a convex portion is formed in one of engagement surfaces opposing to each other within the sipe, and a dimple engaging with the convex portion is formed in the other.

A pneumatic tire disclosed in the patent Japanese Unexamined Patent Publication No. 2000-6619 is structured such that a waveform sipe is formed as a three-dimensional shape by changing an amplitude of the waveform sipe at a position in a depth direction.

A pneumatic tire proposed in the Japanese Patent No. 3516647 solves the problems in the techniques of the Japanese Unexamined Patent Publication No. 1993-58118 and Japanese Unexamined Patent Publication No. 2000-6619, and aims to provide a pneumatic tire which can obtain a sufficient engaging force in a depth direction while making good use of an advantage of the waveform sipe, and is hard to be affected in an inhibiting effect in accordance with a collapsing direction of the block. The pneumatic tire has a reference surface extending in the depth direction from a wavy line or a zigzag line on a surface of the block, and has a sipe in which an engagement surface having a concave vertical cross section is provided in each of a front surface side top portion and a back surface side top portion of the reference surface.

### SUMMARY OF THE INVENTION

However, in the studless tire mentioned above, since only the convex portion is formed in one of the engagement surfaces, the collapse inhibiting operation is differentiated in accordance with the collapsing direction of the block. Accordingly, there is a problem that the collapse inhibiting operation in any direction becomes insufficient. In other words, a pressure contact force of the engagement portions between the convex portion and the dimple is enlarged in the collapse of the block to the protruding side of the convex portion, whereby the collapse inhibiting operation becomes large, however, the pressure contact force of the engagement portion between the convex portion and the dimple becomes small in the collapse in an inverse direction, whereby the collapse inhibiting operation becomes small. Further, since it is assumed that the sipe is constituted by a flat sipe (a linear sipe), there is a defect that the direction of the edge effect is inhibited in comparison with the waveform sipe.

In the Japanese Unexamined Patent Publication No. 2000-6619, there has been proposed the tread pattern in which the waveform sipe is formed as the three-dimensional shape by changing the amplitude of the waveform sipe at the position in the depth direction. However, since a sufficient engagement force with respect to a displacement in a depth direction of a wall surface is hard to be obtained only by the change of the amplitude, the collapse inhibiting effect of the sipe tends to become insufficient.

Further, in the pattern in the Japanese Patent No. 3516647, the sipe extends in the depth direction from the wavy line or the zigzag line on the surface of the block, the wave is provided with the engagement surface, and the collapse of the sipe is prevented by the engagement between the wave and the concavity and convexity. Accordingly, the structure in the Japanese Patent No. 3516647 is more excellent than the case of Japanese Unexamined Patent Publication No. 12-6619 mentioned above, however, it is requested to improve the collapse inhibiting effect of the sipe.

An object of the present invention is to provide a pneumatic tire which can obtain a sufficient engagement force in a depth direction in comparison with the pattern in the Japanese Patent No. 3516647 while making good use of an advantage of the waveform sipe, and is hard to be affected in an inhibiting effect in accordance with a collapsing direction of the block.

The present invention provides a pneumatic tire provided with a tread pattern having a plurality of blocks forming a plurality of sipes therein,

wherein the sipe is formed in a zigzag or wavy line shape on a surface of the block and formed as a waveform groove in a depth direction, and

wherein the waveform groove has an auxiliary wavy portion in a wavy surface direction, and has a concave portion in a peak portion of the wave.

In accordance with the tread pattern having the structure mentioned above, it is possible to obtain the pneumatic tire which can obtain the sufficient engagement force in the depth direction in comparison with the pattern in the Japanese Patent No. 3516647, while making good use of the advantage of the waveform sipe, and the inhibiting effect is not affected in accordance with the collapsing direction of the block.

The sipe forming member arranged in the metal mold for forming the tire forming the three-dimensional sipe in accordance with the present invention has an effect that the sipe forming member is comparatively easily manufactured, in comparison with the other complex sipe shape forming members.

### BRIEF DESCRIPTION OF THE DRAWINGS

FIG. 1 is a plan view of a tire tread portion;

FIG. 2 is a perspective view of a block including a partial cross section showing a shape of a sipe;

FIG. 3 is a front elevational view of a convex stripe 12a in FIG. 2 as seen from an opposed rubber portion 23 side; and

FIG. 4 is a cross sectional view along a line X-X in FIG. 2.

### DETAILED DESCRIPTION OF THE PREFERRED EMBODIMENTS

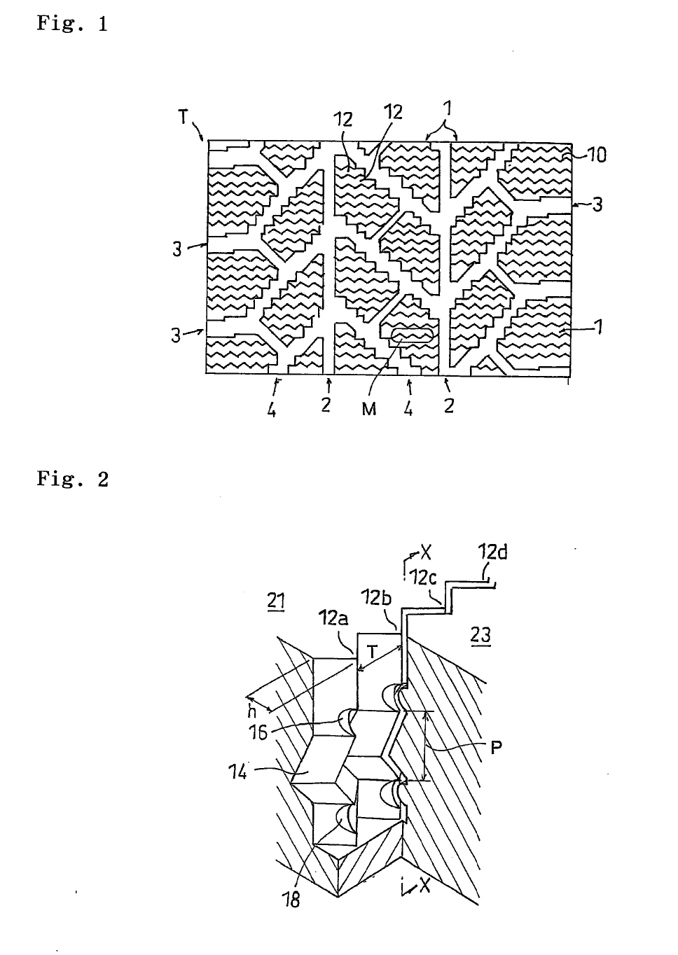

A description will be given of a preferable embodiment in accordance with the present invention with reference to the accompanying drawings. FIG. 1 is a plan view of a tire tread portion. A pneumatic tire in accordance with the present invention is provided with a tread pattern T having a plurality of blocks 1 forming a plurality of sipes 10 therein. In the present embodiment, there is formed a quadrangular or pentagonal block 1 comparted by a circumferential groove 2, a horizontal groove 3 and a diagonal groove 4, and six rows of blocks 1 are arranged in a tire width direction. In the sipe exemplified in FIG. 1, a shape appearing on a block surface of the tread has a zigzag shape. In the case of the zigzag shape, it is preferable that an angular portion (a peak and a trough of the zigzag) is formed in a circular arc shape. In the case that the sipe is formed in a wavy form, the wavy form is not particularly limited, but can be exemplified by a wavy form similar to a sine wave, a wavy line obtained by alternately combining a straight line and a curved line, a wavy form similar to a rectangular wave and the like.

In a state exemplified in FIG. 1, plural rows of sipes 10 are formed toward a tire width direction, in each of the blocks 1, and each of the sipes 10 is open to a groove which is adjacent to the block 1. In the present invention, the sipe is not limited to the aspect, but can appropriately use properly a sipe which is held in an inner side of a side wall of the block 1 without being exposed to the side wall of the block 1, a sipe which is held only in one side, and the like, in accordance with a pattern structure.

It is preferable that a period of the wavy line or the zigzag line in the sipe 10 is between 1.5 and 4.0 mm for preferably generating a characteristic of a so-called waveform sipe, and it is preferable that an amplitude (h) is between 1.0 and 2.5 mm. Further, it is preferable that a depth of the sipe 10 is between 3 and 10 mm.

In the present invention, the collapse inhibiting effect of the block 1 by the engagement surface becomes large in accordance that the groove width of the sipe 10 is smaller, however, if the groove width is too small, the edge portion is hard to be generated, and the edge effect is lowered. Accordingly, it is preferable that the groove width of the sipe is between 0.2 and 0.7 mm. Further, it is preferable that a density of the sipe corresponding to a sipe length per unit area of the block 1 is between 0.1 and 0.3 mm/mm², and it is more preferable that it is between 0.15 and 0.3 mm/mm².

FIG. 2 is a perspective view showing a part, for example, a portion M in FIG. 1, of the block including a partial cross section in an enlarged manner, and shows a shape of the sipe. In this drawing, there is exemplified the sipe in which the shape appearing on a surface of the block 1 of the tread is a zigzag shape. The sipe 10 is formed as a waveform groove between rubber portions 21 and 23 of the block, and the waveform groove has such a structure that convex stripes 12a, 12b, 12c, 12d, . . . formed in the rubber portion 21 continuously in the depth direction of the block and having an approximately triangular shape, and a convex stripe 13 formed in an opposed rubber portion 23 in the groove formation face to a trough corresponding to a connection portion of the convex stripe of the rubber portion opposed to a top portion of the convex stripe. A period of the zigzag or waveform sipe on the surface of the block is T, and an amplitude thereof is h. In the example in FIG. 2, a point of the peak and a bottom of the trough of the convex stripe are sharp, however, it is preferable that they are formed in a circular arc shape as mentioned above.

The convex stripe 12 (12a, 12b, . . . ) has an auxiliary waveform portion 14 in a wavy surface direction formed by the convex stripe, and concave portions 16 and 18 in which a peak portion of the wave formed by the convex stripe is concave are formed in the convex stripe 12. The number of the concave portions may be set to one or three, although FIG. 2 shows the example having two concave portions. The number of the concave portions is not limited particularly. Further, a position of the concave portion is not particularly limited. Further, FIG. 2 shows the example of the auxiliary waveform portion in which one C-shaped wave is formed, however, the auxiliary waveform portion may be structured such that a whole of the convex stripe is formed in a wavy shape, and a shape of the wave is not particularly limited, but may be formed in a sine wave or the like.

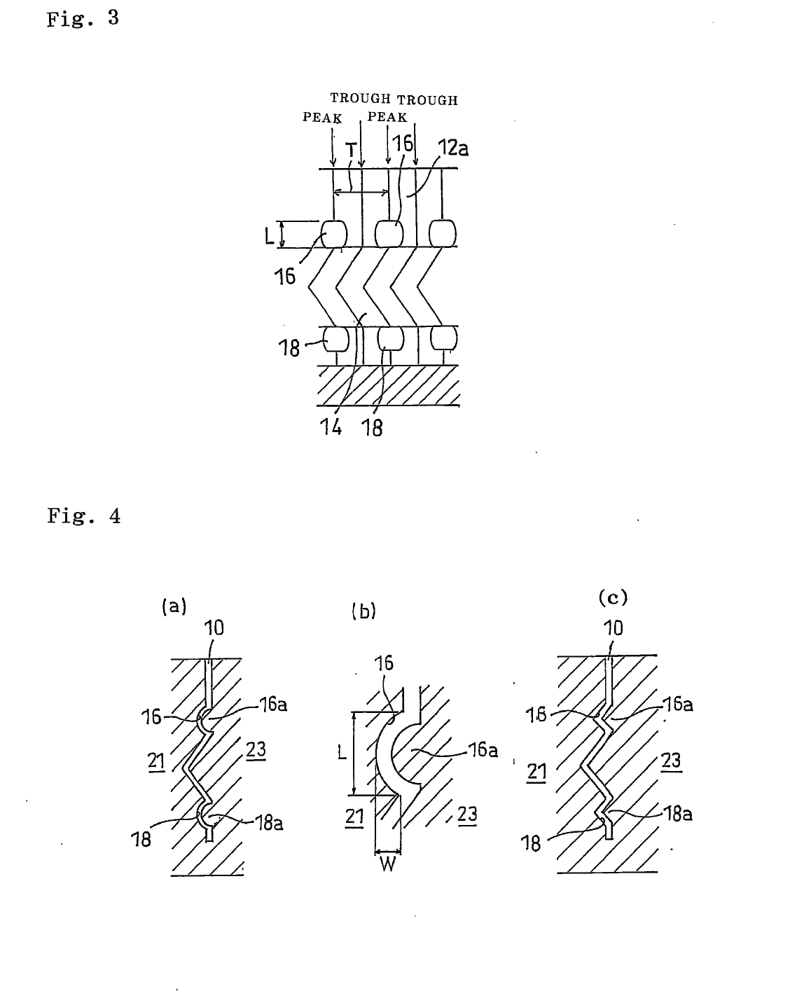

FIG. 3 is a front elevational view of the convex stripe 12a in FIG. 2 as seen from the opposed rubber portion 23 side. One C-shaped auxiliary waveform portion 14 is formed in the convex stripe 12a, and two concave portions are formed in a groove shape vertically to the depth direction of the sipe (16, 18). It is preferable that an amplitude H of the auxiliary waveform portion 14 is between 1 and 4 mm.

FIG. 4 is cross sectional views along a line X-X in FIG. 2, in which FIG. 4(a) shows an example in which a cross sectional shape of the concave portions 16 and 18 is formed in a circular arc shape, and FIG. 4(b) is a view showing a portion of the concave portion in FIG. 4(a)in an enlarged manner. FIG. 4(c) shows an example in which the cross sectional shape of the concave portions 16 and 18 is formed in a V-shaped form. Concave portions 16a and 18a are formed in the trough of the convex stripe 13 formed so as to be continuously in contact with the opposed rubber portion 23 in such a manner as to be spaced at the groove width of the sipe 10, in relation to the concave portions 16 and 18 formed in the peak portion of the convex stripe 12 (12c) of the rubber portion 21 constructing the groove of the sipe, and the engagement portions are structured by the concave portion and the convex portion, which engage at a deforming time of the block at a time when the tire is grounded, and achieve an operation of inhibiting the collapse of the block.

It is preferable that the depth W of the concave portions 16 and 18 formed in the peak portion of the sipe 10 is equal to or less than one half of an amplitude (h) of the wavy line or the zigzag line of the sipe 10, and it is more preferable that it is between 0.5 and 1.0 mm. If the depth W is less than 0.5 mm, the collapse inhibiting effect of the sipe 10 tends to become insufficient, and if it becomes more than 1.0 mm, a resistance tends to become large at a time of releasing from the mold after a tire vulcanization molding.

Further, it is preferable that a magnitude L of an opening portion of the concave portion 16 is between 0.5 and 2.5 mm. If the magnitude L of the opening portion is less than 0.5 mm, the collapse inhibiting effect of the block 1 tends to become insufficient, and if it becomes more than 2.5 mm, an angle of inclination or a curve with respect to the convex portion of the opposed rubber portion becomes smaller in the groove formation relatively, for example, with respect to the concave portion 16, in a relation to the depth W, so that the collapse inhibiting effect of the block 1 tends to become insufficient.

In the case that a plurality of concave portions is provided in one convex stripe, the magnitudes thereof (the magnitude L of the opening portion and the depth W) may be identical or different. In the case that a plurality of concave portions are provided in one convex stripe, if an interval P (refer to FIG. 2) is too small, the rubber portion spacing the adjacent concave portions becomes thin and a rigidity is lowered, whereby the collapse inhibiting effect of the block structure rubber portion becomes insufficient. Accordingly, it is preferable that the interval P is equal to or more than 1 mm. The concave portions shown in FIGS. 2 to 4 are formed in the groove shape, however, may be formed in such a semispherical shape as to be formed from the convex peak portion. In this case, the depth of the concave portion means a maximum depth.

In the pneumatic tire in accordance with the present invention, the concave portion formed in the sipe is preferably structured such that a depth of a center portion of the block is shallower than a depth of a shoulder portion. In accordance with the structure mentioned above, since the collapse of the block in the center portion is larger than the block in the shoulder portion, there is obtained a tire which is effective in an ice braking, and is effective in a dry handling because the collapse of the shoulder portion is smaller than the center portion. Accordingly, it is possible to obtain a tire having a good balance in the ice braking and the dry handling performance. It is preferable that the sipe having the concave portion having the shallow depth is closest to each side of the block.

Since the pneumatic tire in accordance with the present invention achieves the operation and effect as mentioned above, and is excellent in the ice performance, the pneumatic tire is useful as the studless tire.

An embodiment of the present invention will be explained with reference to the drawings. An evaluation of each of performances is executed as follows.

### (1) Ice Braking Performance

A tire is installed to an actual car (FF sedan of Japanese 3000 cc class), and is traveled on an icy road surface under a load condition of one person riding, and a braking distance at a time of applying a braking force at a speed 40 km/h so as to fully lock is evaluated by an index number. In this case, the evaluation is expressed by an index number indication at a time of setting a conventional product (a comparative example 1) to 100, and a better result is indicated in accordance that the numerical value is greater.

### (2) Dry Handling Performance

The tire is installed to all the wheels of the actual car mentioned above, a straight travel, a turning travel, a braking and the like are executed on a dry road surface, and a handling performance is evaluated in accordance with a sensory test by a driver. The evaluation is expressed by an index number indication at a time of setting the comparative example 1 to 100, and a more excellent dry performance is indicated in accordance that the numerical value is greater.

### EXAMPLES 1 AND 2

In the tread pattern shown in FIG. 1, a radial tire having a size 205/65R15 is manufactured by forming a sipe having the shape as shown in FIG. 2 and a sine wave form. A depth of the sipe is 7 mm, a groove depth is 0.3 mm, an amplitude (h) is 2 mm, a period is 2 mm, two concave portions (engagement surfaces) having a circular arc cross sectional shape as shown in FIG. 2 are provided, and a center thereof is set such that a depth from the block surface is 3 mm and 6 mm. An auxiliary wavy portion is formed approximately in a C-shaped form as shown in FIG. 2, an amplitude H is 1.5 mm, and a depth of the concave portion is set to be uniform in the same convex stripe constructing the sipe and is shown in table 1. A result obtained by using the tire and carrying out each of the performance evaluations mentioned above is shown in table 1.

### COMPARATIVE EXAMPLE 1

In the example 1, a radial tire having a size 205/65R15 is manufactured by setting the amplitude (h) of the sipe to 2 mm, and employing the same structure except the concave portion being formed, and each of the performance evaluation mentioned above is executed. A result thereof is shown in table 1.

### COMPARATIVE EXAMPLE 2

In the example 1, a radial tire having a size 205/65R15 is manufactured by setting the amplitude (h) of the sipe to 3 mm, and employing the same structure except the concave portion being formed, and each of the performance evaluation mentioned above is executed. A result thereof is shown in table 1.

TABLE 1

| | | | | Compar- | Compar- |
|---|---|---|---|---|---|
| | | Exam- | Exam- | ative | ative |
| | | ple 1 | ple 2 | Example 1 | Example 2 |
| Amplitude of sipe (h) (mm) | | 2 | 2 | 2 | 3 |
| Depth of | Center portion | 1.0 | 0.6 | — | — |
| concave | (mm) | | | | |
| portion | Shoulder portion | 1.0 | 1.4 | — | — |
| | (mm) | | | | |
| Result of | Ice braking | 105 | 108 | 100 | 103 |
| evaluation | Dry handling | 107 | 110 | 100 | 103 |

On the basis of the result in table 1, it is known that the tire provided with the sipe in accordance with the present invention is more excellent than the performance of the conventional tire in both of the ice braking and the dry handling performance. In particular, the tire in accordance with the example 2 in which the depth of the concave portion in the center of the block is set shallower than the shoulder portion exhibits the particularly excellent performance.

What is claimed is:

1. A pneumatic tire provided with a tread pattern having a plurality of blocks forming a plurality of sipes therein,
wherein the sipe is formed in a zigzag or wavy line shape on a surface of the block and formed as a waveform groove in a depth direction, and
wherein the waveform groove has an auxiliary wavy portion in a wavy surface direction, and has a concave portion in a peak portion of the wave.

2. A pneumatic tire as claimed in claim 1, wherein a depth of the concave portion is between 0.5 and 1.5 mm.

3. A pneumatic tire as claimed in claim 1, wherein a height of the auxiliary wavy portion is between 1.0 and 5.0 mm.

4. A pneumatic tire as claimed in claim 1, wherein the concave portion is structured such that a depth in a center portion of the block is shallower than a depth of a shoulder portion.
